(19) United States
(12) Patent Application Publication
(10) Pub. No.: US 2012/0074705 A1
(43) Pub. Date: Mar. 29, 2012

(54) COUNTER ROTATING WIND TURBINE POWER GENERATION

(75) Inventors: Bradley Kyle Stephens, Reno, NV (US); Daryl Price, Reno, NV (US)

(73) Assignee: Renewable Green Products Inc., Reno, NV (US)

(21) Appl. No.: 12/889,670

(22) Filed: Sep. 24, 2010

(51) Int. Cl. F03D 11/02; F03D 9/00; F03D 3/02

(52) U.S. Cl. 290/55; 416/128; 416/146 R

(57) ABSTRACT

According to the invention, a system for generating electricity from wind is disclosed. The system may include a vertical mounting pole, a generator, a first vertical axis wind turbine (“VAWT”), and a second VAWT. The generator may include a rotor, stator, and frame, fixedly coupled with the stator, and rotatably coupled with the vertical mounting pole such that the generator can rotate around a substantially vertical axis. The first VAWT may be fixedly coupled with the frame and configured to rotate in a first rotational direction around the vertical axis, and at least partially about the vertical mounting pole, when a wind is received. The second VAWT may be fixedly coupled with the rotor and configured to rotate in a second rotational direction around the vertical axis, and at least partially about the generator, when the wind is received, where the second rotational direction is opposite the first rotational direction.

### BACKGROUND OF THE INVENTION

This invention relates generally to power generation systems and methods. More specifically, the invention relates to wind powered power generation systems and methods.

### BRIEF DESCRIPTION OF THE INVENTION

In one embodiment, a system for generating electricity from wind is provided. The system may include a vertical mounting pole, a generator, a first vertical axis wind turbine (“VAWT”), and a second VAWT. The generator may include a rotor, a stator, and a frame fixedly coupled with the stator. The frame may be rotatably coupled with the vertical mounting pole such that the generator can rotate around a substantially vertical axis. The first VAWT may be fixedly coupled with the frame and configured to rotate in a first rotational direction around the substantially vertical axis, and at least partially about the vertical mounting pole, when a wind is received by the first VAWT. The second VAWT may be fixedly coupled with the rotor and configured to rotate in a second rotational direction around the substantially vertical axis, and at least partially about the generator, when the wind is received by the second VAWT, and where the second rotational direction is opposite that of the first rotational direction.

In another embodiment, a system for generating electricity from fluid flow is provided. The system may include a first means, a second means, a third means, a fourth means, and a fifth means. The first means may be for generating electricity from an input of a first rotational motion, where the first means is rotated by a second rotational motion. The first means may include a generator. The second means may be for converting at least a portion of energy from a fluid flow into a first rotational motion having a first rotational direction. The second means may include a VAWT having vanes in a first direction. The third means may be for converting at least a portion of energy from the fluid flow into a second rotational motion having a second rotational direction opposite the first rotational direction. The third means may include a VAWT having vanes in a second direction opposite the first direction. The fourth means may be for transmitting the first rotational motion to the first means. The fifth means may be for transmitting the second rotational motion to the first means. The fourth means and the fifth means may each include a mechanical transmission system.

In another embodiment, a method for generating electricity from fluid flow is provided. The method may include receiving a fluid flow with a first VAWT and a second VAWT. The method may also include converting energy from the fluid flow into a first rotational motion with the first VAWT. The method may further include converting energy from the fluid flow into a second rotational motion with the second VAWT, where the second rotational motion is in an opposite direction of the first rotational motion. The method may additionally include receiving, with a generator, the first rotational motion from a first side of the generator, and the second rotational motion from a second side of the generator, the first side opposite the second side.

### BRIEF DESCRIPTION OF THE DRAWINGS

The present invention is described in conjunction with the appended figures:

FIG. 1 is a side section view of an unassembled mechanical/electrical transmission set of various embodiments of the invention, along with vertical mounting pole and generator;

FIG. 2 is a side section view of the components of FIG. 1 shown in an assembled state;

FIG. 3 is a side section view of the assembly of FIG. 2 with vertical axis wind turbines also coupled with the system;

FIG. 4 is side view of the assembly of FIG. 3;

FIG. 5A is a side view of the assembly of FIG. 3 as seen from a distance with vertical mounting pole coupled with a surface;

FIG. 5B is a side view of the embodiment shown in FIG. 5A, except also incorporating a photovoltaic module;

FIG. 6 is a side view of two assemblies of FIG. 3, except inverted and mounted in tandem;

FIG. 7 is a side view of two assemblies of FIG. 3, except inverted and mounted on a movable element with solar panels, where the movable element may move up and down the vertical mounting pole; and

FIG. 8 is a block diagram of a method embodiment of the invention for generating power.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

In one embodiment of the invention, a system for generating electricity from wind is provided. The system may include a vertical mounting pole, a generator, a first vertical axis wind turbine (“VAWT”), and a second VAWT. The generator may include a rotor, a stator, and a frame fixedly coupled with the stator. The frame may be rotatably coupled with the vertical mounting pole such that the generator can rotate around a substantially vertical axis. The first VAWT may be fixedly coupled with the frame and configured to rotate in a first rotational direction around the substantially vertical axis, and at least partially about the vertical mounting pole, when a wind is received by the first VAWT. The second VAWT may be fixedly coupled with the rotor and configured to rotate in a second rotational direction around the substantially vertical axis, and at least partially about the generator, when the wind is received by the second VAWT, and where the second rotational direction is opposite that of the first rotational direction.

The vertical mounting pole may be any structure, made from any number of possible materials, and in any possible shape, which can support the other features of the embodiments described herein. Merely by way of example, the vertical mounting pole may be made from steel, aluminum, polymer, or composite materials. The vertical mounting pole may couple the ground or may couple some other structure with the remaining portions of the embodiments. Again, by way of example, the vertical mounting pole may allow the remaining portions of the embodiments to hang from the bottom of the vertical mounting pole, while the top of the vertical mounting pole is coupled with some other structure, possibly a mounting pole via an arm to achieve some distance from the mounting pole. In some embodiments, the vertical mounting pole may be raised, or lowered to a near-to-ground horizontal orientation, via a mechanical device, such as a hydraulic cylinder and a hinged connection at the lower extremity. This may permit maintenance on the systems of the invention in easier to reach positions.

Thus, in one embodiment, the vertical mounting pole may be coupled with a surface (possibly the ground) at a bottom portion of the mounting pole, and the frame being rotatably coupled with the vertical mounting pole may include the vertical mounting pole being coupled with the generator at a top portion of the mounting pole. In an alternative embodiment, the vertical mounting pole may be coupled with a support member at a top portion of the vertical mounting pole, and the frame being rotatably coupled with the vertical mounting pole may include the vertical mounting pole being coupled with the generator at a bottom portion of the vertical mounting pole.

In embodiments where the vertical mounting pole is coupled with the generator at a bottom portion of the mounting pole, and the top of the vertical mounting pole is coupled with a support member, the system may further include a vertical support element. The support member may then be selectively movably coupled with a vertical support element such that the support member moves vertically along a length of the vertical support element. In this manner, embodiments of the invention may be raised to a certain height during operation and lowered for maintenance when necessary. A movement device, many of which are known in the art, may be coupled with the vertical support member and any other portion of the embodiments to facilitate automatic, semi-automatic, or manual movement of the system between the top and bottom of the vertical support member.

In some of embodiments, the system may include a plurality of photovoltaic modules coupled with the support member such that the photovoltaic modules surround a horizontal cross-section of the vertical support element when the support member moves along the length of the vertical support element. In this manner, because the photovoltaic modules surround the horizontal cross-section of the vertical support element, when the support member moves up and down the vertical support element, the photovoltaic modules may also move up and down the vertical support element. Additionally, in some of these embodiments the support member, or any element attached thereto, may rotate about the vertical support element and its substantially vertical axis. This may allow any element of the embodiments, and most particularly, the photovoltaic modules, to be orientated to face a solar source for maximum energy production. In this manner, embodiments of the invention may provide for hybrid power generation, combining solar and wind power generation.

The generator may be an alternating current (AC) or direct current (DC) generator. The generator may have a rotor and a stator, and corresponding armature/field and field/armature. The frame of the generator may be fixedly coupled with the stator. In various embodiments of the invention, the first VAWT may be coupled with the frame, and the second VAWT may be coupled with the rotor. This may include the first VAWT being coupled with a first side of the generator and the second VAWT being coupled with an second, opposite, side of the generator.

In some embodiments, the frame may be rotatably coupled with the vertical mounting pole. In these or other embodiments this may include the frame being coupled with one or more bearings (understood to possibly include bushings and other rotatable interfaces), and the bearing(s) coupled with the vertical mounting pole. Merely by way of example, such bearings may include plain bearings (including bushings), roller element bearings, magnetic bearings, fluid bearings, and various sup types of these bearings such as thrust bearings to support loads along the axis of the bearing.

In some embodiments, the frame being coupled with the bearing may include a configuration where the frame may be coupled with a first chassis, and the first chassis may be coupled with the bearing. In these configurations, the bearing coupled with the vertical mounting pole may include the bearing being coupled with a second chassis, and the second chassis coupled with the vertical mounting pole.

In some embodiments, the system may also include a slip ring at some interface between the generator and the vertical mounting pole. In some of the above described embodiments, this may include a slip ring at the interface between the first chassis and the second chassis. A slip ring may be any slip ring known in the art for transmitting power between a rotating element and a non-rotating element. In the embodiments described herein, the slip ring facilitates electricity passing between the generator as it rotates and a conductor in the vertical mounting pole (for example, conductive wiring), where the conductor in the vertical mounting pole is stationary.

The first VAWT and the second VAWT may be configured to rotate in opposite directions when receiving or experiencing a common wind or other motion from a fluid source flowing over and through the VAWTs. This may be because the vanes of each VAWT are oriented in a direction opposite that of the other VAWT.

Each VAWT may be any sort of vertical axis wind turbine, either now known or developed in the future, which converts a generally horizontal fluid motion vector into a rotating motion about the vertical axis of the VAWT. Merely by way of example, and without limitation, each VAWT may include Savonius blades, Darrieus blades, helical twisted blades, and/or giromill blades. Each VAWT may have different blade configurations than the other VAWT.

The size of the VAWTS may vary depending on the embodiment. Merely by way of example, in an exemplary embodiment the ratio of a total diameter of the first VAWT to a total height of the first VAWT may be substantially 7:8. In these or other embodiments, the ratio of a total diameter of the second VAWT to a total height of the second VAWT may be substantially 7:6. In some embodiments, the second VAWT may have substantially the same ratio of total diameter to total height as the first VAWT. In other embodiments, the second VAWT may have a different total diameter to total height ratio than the first VAWT.

In some embodiments, a ratio of a total height of the first VAWT to a total height of the second VAWT may be substantially 4:3. In other embodiments, the ratio of total height of the first VAWT to the second VAWT may be substantially 1:1. In other embodiments, the ratio may be between 1:1 and 4:3. In yet other embodiments, the ratio may be less than 1:1, or possibly greater than 4:3.

In another embodiment of the invention, a system for generating electricity from a fluid flow is provided. The system may include a first means, a second means, a third means, a fourth means, and a fifth means.

The first means may be for generating electricity from an input of a first rotational motion, where the first means is rotated by a second rotational motion. The first means may include a generator, other components described herein, and/or the equivalents thereof, capable of at least assisting in generating electricity from an input of a first rotational motion, where the first means is rotated by a second rotational motion.

The second means may be for converting at least a portion of energy from a fluid flow into a first rotational motion having a first rotational direction. The second means may include a VAWT having vanes in a first direction, other components described herein, and/or the equivalents thereof, capable of converting at least a portion of energy from a fluid flow into a first rotational motion having a first rotational direction.

The third means may be for converting at least a portion of energy from the fluid flow into a second rotational motion having a second rotational direction opposite the first rotational direction. The third means may include a VAWT having vanes in a second direction opposite the first direction, other components described herein, and/or the equivalents thereof, capable of converting at least a portion of energy from the fluid flow into a second rotational motion having a second rotational direction opposite the first rotational direction.

The fourth means may be for transmitting the first rotational motion to the first means. The fifth means may be for transmitting the second rotational motion to the first means. The fourth means and the fifth means may each include a mechanical transmission system, other components described herein, and/or the equivalents thereof, capable of transmitting the first rotational motion or the second rotational motion to the first means. Merely by way of example, the first means may include the second chassis, or any other element/feature described herein, which couples the first VAWT with the frame of the generator. As an example of the second means, such may be a VAWT plate described below to couple the second VAWT with the rotor of the generator.

In some embodiments, the system may also include a sixth means. The sixth means may be for rotatably coupling the first means with a surface. The sixth means may include a vertical mounting pole, other components described herein, and/or the equivalents thereof, capable of rotatably coupling the first means with a surface.

In another embodiment of the invention, a method for generating electricity from fluid flow is provided. The method may include receiving a fluid flow with a first VAWT and a second VAWT. The method may also include converting energy from the fluid flow into a first rotational motion with the first VAWT. The method may further include converting energy from the fluid flow into a second rotational motion with the second VAWT, where the second rotational motion is in an opposite direction of the first rotational motion. The method may additionally include receiving, with a generator, the first rotational motion from a first side of the generator, and the second rotational motion from a second side of the generator, the first side opposite the second side.

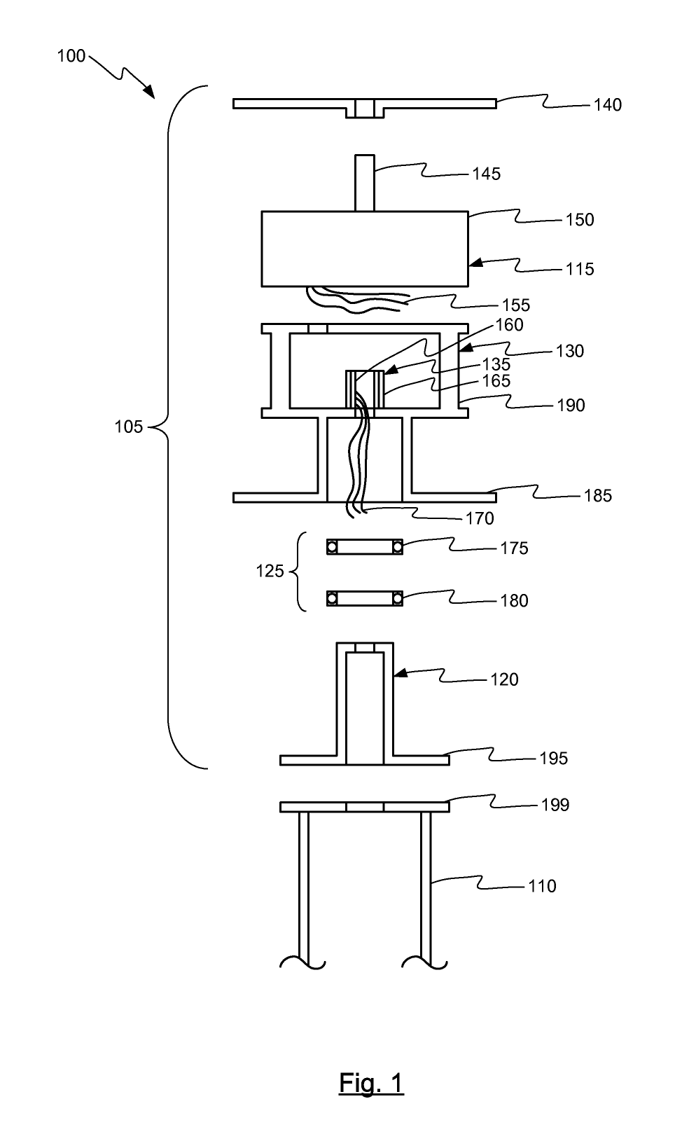

Turning now to FIG. 1, a side section view 100 of an unassembled mechanical/electrical transmission set 105 of various embodiments of the invention, along with vertical mounting pole 110 and generator 115, is shown. Mechanical/electrical transmission set 105 may include a first chassis 120, a bearing set 125, a second chassis 130, a slip ring 135, and a second VAWT plate 140.

Generator 115 may include a rotor 145, frame 150, and electrical/control/sensor leads 155. As discussed herein, rotor 145 may rotate relative to a stator (not shown) inside generator 115, with the stator fixedly coupled with frame 150. The rotation of the rotor relative to the stator may cause generator 115 to produce electricity which is then transmitted via leads 155. Leads 155 may also provide communicative means to issue control commands and/or receive sensor readings from generator 115.

Slip ring 135 may include an interior portion 160 and an exterior portion 165 which allow for the transmission of electrical power/signals between the two portions 160, 165 when the two portions 160, 165 rotate relative to each other. Once assembled, leads 155 may be coupled with exterior portion 165, and so while exterior portion 165 rotates with second chassis 130 and generator 115, interior portion 160 may remain stationary, along with first chassis 120 and vertical mounting pole 110. Leads 170 may transfer electrical power/signals from interior portion 160 through first chassis 120 and vertical mounting pole 110 to their final destination.

Bearing set 125 is shown in this embodiment as including a first bearing 175 and a second bearing 180. In other embodiments, fewer or greater number of bearings may be present. In this embodiment, bearing 175 may be a thrust bearing, and bearing 180 may be a roller bearing.

Second chassis 130 includes a first VAWT plate 185, and a accessible “cage” area for configuration of slip ring 135 connections. The “cage” is surrounded by interspaced structural members 190 which allow for access in-between such structural members 190.

First chassis 120 includes a attachment flange 195 which may be coupled with corresponding flange 199 on vertical mounting pole 110. As with all couplings described or pictured herein, any means of coupling may employed, including, but not limited to, nuts and bolts, machine screws, riveting, welding, interference fitting, chemical/thermal adhesives, etc.

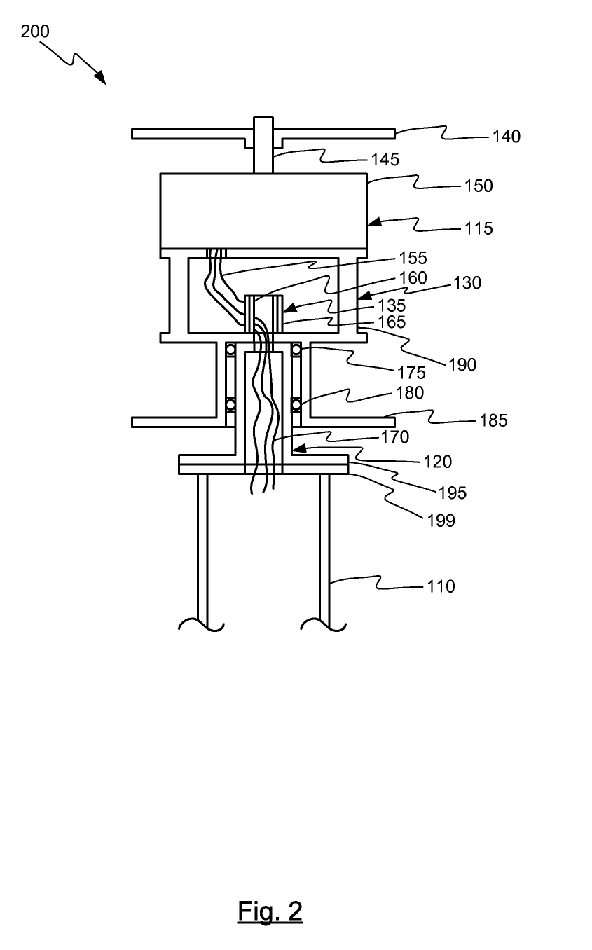

FIG. 2 shows a side section view 200 of the components of FIG. 1 shown in an assembled state. As discussed above, in an alternative embodiment, the assembly of FIG. 2 could be flipped so that mechanical/electrical transmission set 105 and generator 115 could be coupled to the bottom side of vertical mounting pole 110.

In FIG. 2, second VAWT plate 140 is fixedly coupled with rotor 145 via a collar on second VAWT plate 140. Frame 150 of generator 115 is fixedly coupled with the top of second chassis 130. Wiring from generator 115 passes through an orifice in the top of second chassis 130 and is thereafter communicatively coupled with exterior portion 165 of slip ring 135. Interior portion 160 of slip ring 135 is communicatively coupled with leads 170 which pass through orifices in the bottom of second chassis 130 and first chassis 120. The leads further pass through an orifice in flange 199 to proceed down vertical mounting pole 110 where they may be coupled with control and/or power systems. First chassis 120 is rotatably coupled with second chassis 130 via bearings 175, 180. First chassis 120 is fixedly coupled with vertical mounting pole 110.

Note that while the term “fixedly” is referenced with respect to many couplings, these couplings may be fixedly coupled only during system operation, but may be detachable during construction, maintenance, or other non-operational periods. Similarly, “rotatable” couplings rotatable couplings may be rotatable during system operation, but may be modified to be fixed or uncoupled during non-operational periods.

In this manner then, second VAWT plate 140 and rotor 145 are free to rotate with respect to frame 150 (and consequently the stator (not shown) of generator 115). This relative motion produces power at generator 115. Meanwhile, frame 150 and second chassis 130 (including first VAWT plate 185) are free to rotate with respect to vertical mounting pole 110. During both of these possible rotations, leads 170 may remain stationary.

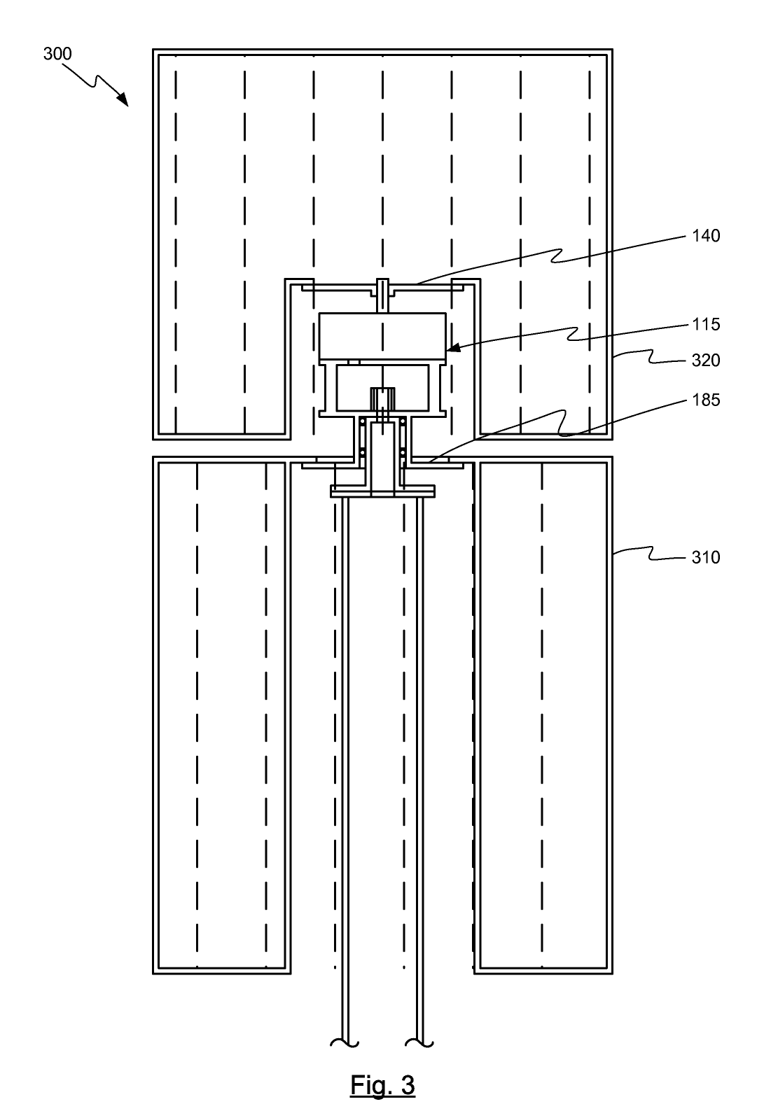

FIG. 3 shows a side section view 300 of the assembly of FIG. 2 with first VAWT 310 and second VAWT 320 also coupled with the system. First VAWT 310 is fixedly coupled with first VAWT plate 185, while second VAWT 320 is fixedly coupled with second VAWT plate 140. As each VAWT may be configured with opposite facing vanes, while first VAWT 310 may rotate in one direction when experiencing/receiving a wind, that same wind may rotate second VAWT 320 in an opposite direction, maximizing relative rotation of the rotor to the stator of generator 115, reducing cut-in speed of generator 115, and increasing the output thereof over a fixed position generator with a single VAWT.

In FIG. 3, first VAWT 310 has a diameter to height ratio of 7:8, and second VAWT 320 has a diameter to height ratio of 7:6. The ratio of first VAWT 310 to second VAWT 320 height in FIG. 3 is 4:3. These ratios, as well as other measurements, vane materials, VAWT structure, etc. may be modified to achieve different efficiencies and outputs, possibly as desired and as a function of climate in the service area.

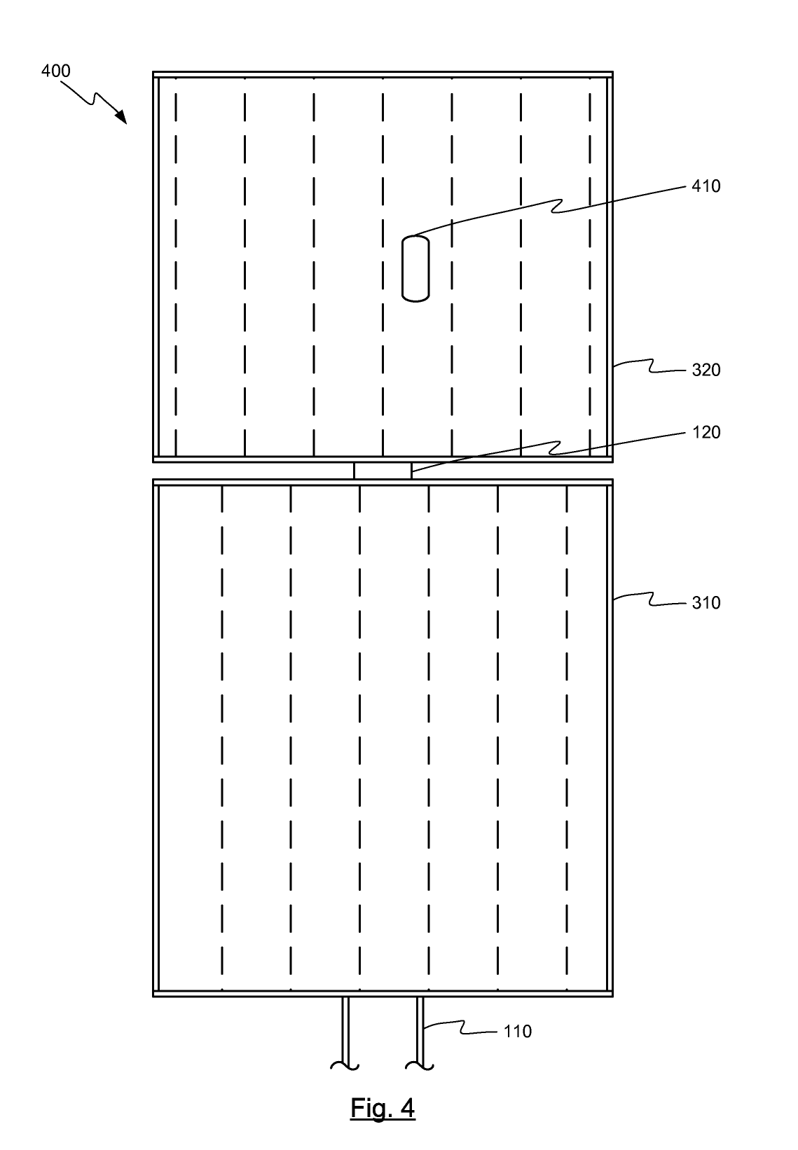

FIG. 4 shows side view 400 of the assembly of FIG. 3. Access panel 410 allows second VAWT 320 to be coupled with second VAWT plate 140. Because when assembled, first VAWT 310 is coupled with first VAWT plate 185 before second VAWT 320 is coupled with the system, no access portal is required for first VAWT 310.

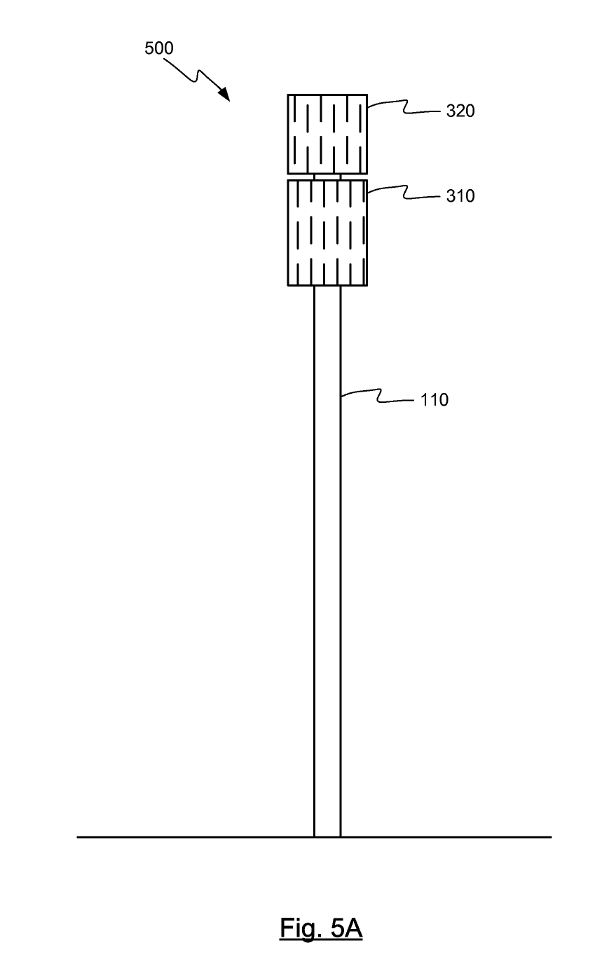

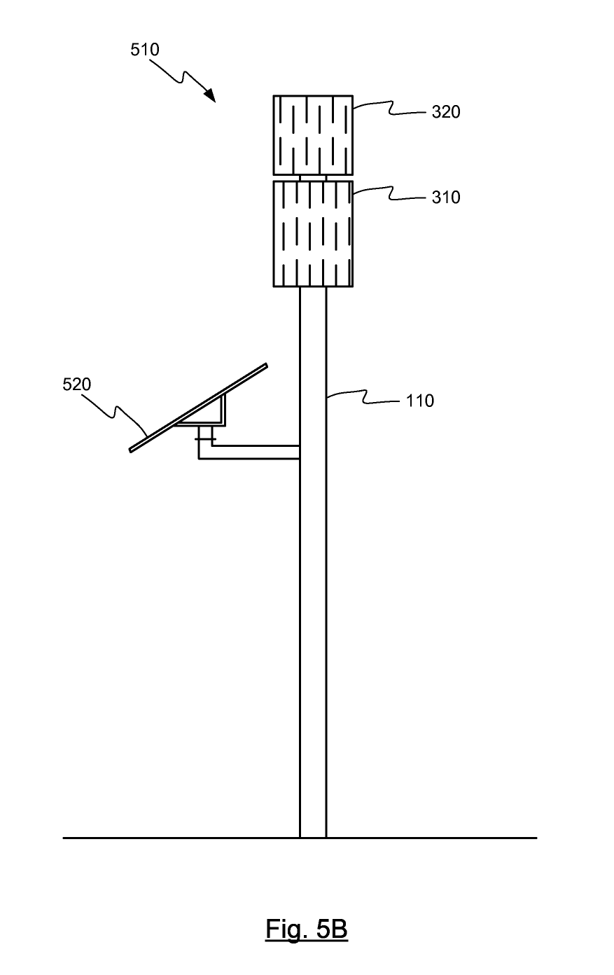

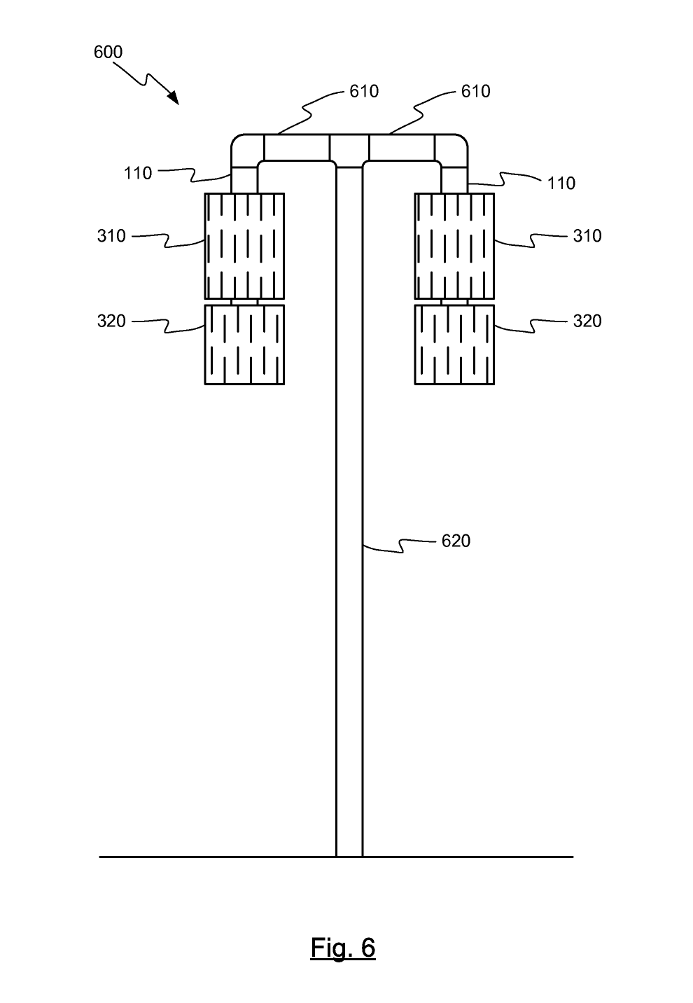

FIG. 5A shows a side view 500 of the assembly of FIG. 3 as seen from a distance with vertical mounting pole 110 coupled with a surface. FIG. 5B shows a side view 510 of an embodiment similar to that shown in FIG. 5A, except including a photovoltaic cell 520 to provide hybrid energy production along with the VAWT assembly of FIG. 3. FIG. 6 shows a side view 600 of two assemblies of FIG. 3, except inverted and mounted in tandem. In this embodiment, each assembly is coupled with vertical mounting pole 110.

Each vertical mounting pole is coupled with a support member 610, and each support member 610 is coupled with a vertical support element 620. In some embodiments, support members 610 may be movable up-and-down vertical support element 620 so that construction/maintenance may be performed on the assemblies.

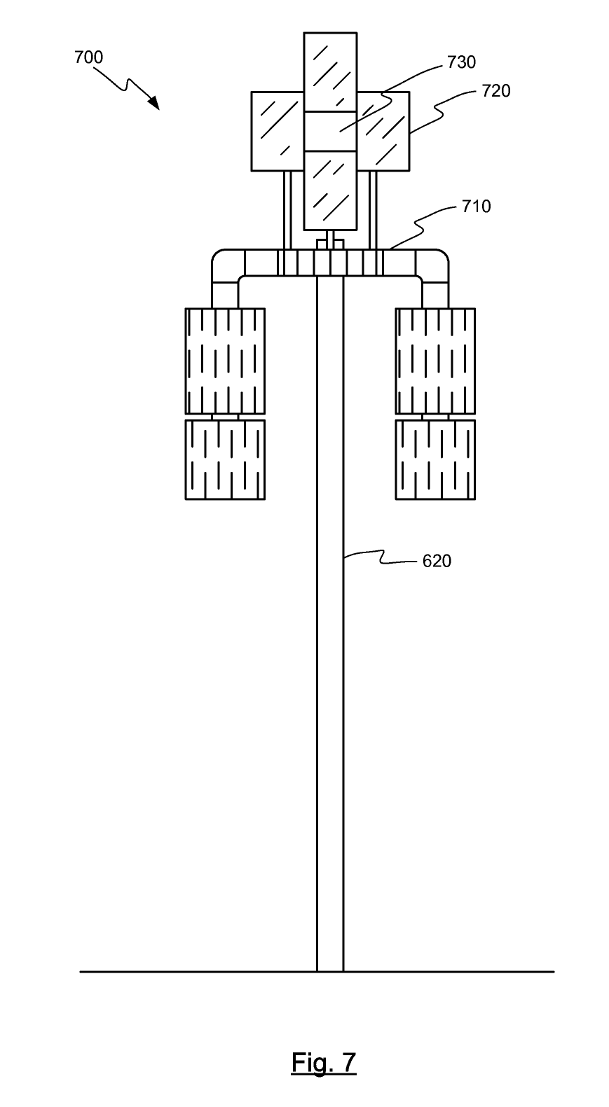

FIG. 7 shows a side view 700 of two assemblies of FIG. 3, except inverted and mounted on a movable element 710 with solar panels 720, where movable element 710 may move up and down vertical support element 620. Gap 730 in solar panels 720 allows vertical support element 620 to traverse through the assembly as movable element 710 moves up-and-down vertical support element 620. Any automatic, semi-automatic, or manual system may be employed to move movable element 710 up-and-down vertical support element 620.

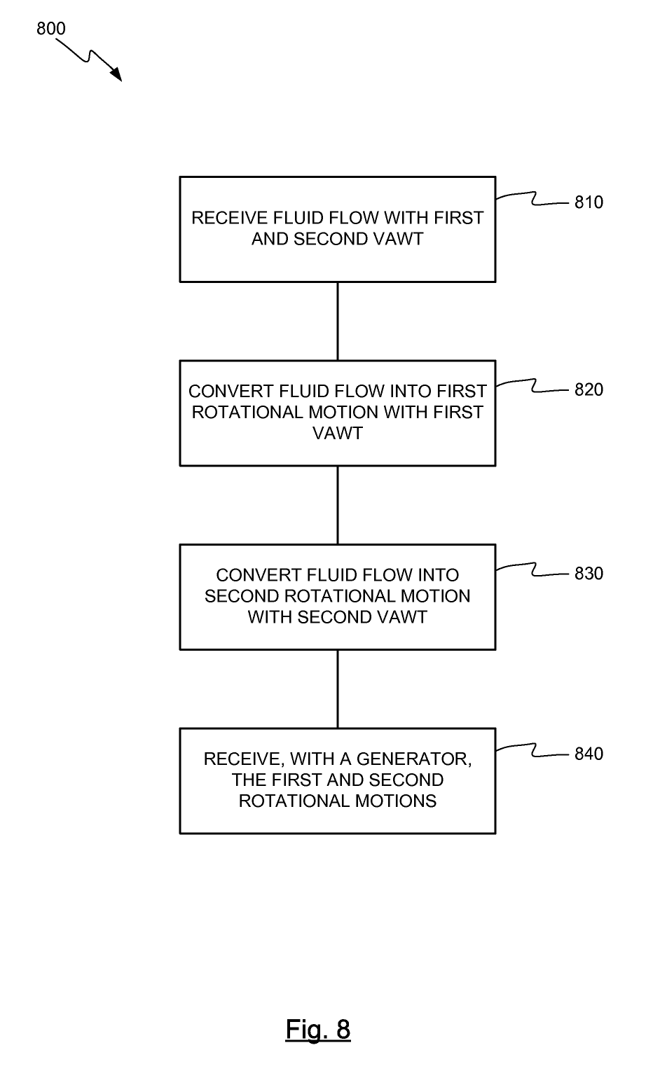

FIG. 8 shows a block diagram 800 of a method embodiment of the invention for generating power. At block 810, the method may include receiving a fluid flow with a first VAWT and a second VAWT. At block 820, the method may also include converting energy from the fluid flow into a first rotational motion with the first VAWT. At block 830, the method may further include converting energy from the fluid flow into a second rotational motion with the second VAWT, where the second rotational motion is in an opposite direction of the first rotational motion. At block 840, the method may additionally include receiving, with a generator, the first rotational motion from a first side of the generator, and the second rotational motion from a second side of the generator, the first side opposite the second side.

A number of variations and modifications of the invention can also be used within the scope of the invention. For example, any of the features described in any of the embodiments discussed herein may be employed in any of the embodiments. As another example, the orientation of the unit may be reversed so that the second VAWT, rather than the first VAWT, is rotatably coupled with the vertical mounting pole. However, in this arrangement an additional slip ring would be necessary: one slip ring between the generator and the first VAWT, and a second slip ring between the first VAWT and the vertical mounting pole. Additionally, the vertical mounting pole could be coupled with the generator via a horizontal arm that rotatably couples with the generator. The horizontal arm could then be coupled with a vertical support element.

The invention has now been described in detail for the purposes of clarity and understanding. However, it will be appreciated that certain changes and modifications may be practiced within the scope of the appended claims.

What is claimed is:

1. A system for generating electricity from wind, wherein the system comprises:
a vertical mounting pole;
a generator, wherein:
the generator comprises:
a rotor;
a stator; and
a frame fixedly coupled with the stator; and
the frame is rotatably coupled with the vertical mounting pole such that the generator can rotate around a substantially vertical axis;
a first vertical axis wind turbine fixedly coupled with the frame, wherein the first vertical axis wind turbine is configured to rotate in a first rotational direction around the substantially vertical axis, and at least partially about the vertical mounting pole, when a wind is received by the first vertical axis wind turbine; and
a second vertical axis wind turbine fixedly coupled with the rotor, wherein the second vertical axis wind turbine is configured to rotate in a second rotational direction around the substantially vertical axis, and at least partially about the generator, when the wind is received by the second vertical axis wind turbine, and wherein the second rotational direction is opposite that of the first rotational direction.

2. The system for generating electricity from wind of claim 1, wherein the first vertical axis wind turbine coupled with the frame and the second vertical axis wind turbine fixedly coupled with the rotor comprises:
the first vertical axis wind turbine coupled with a first side of the generator; and
the second vertical axis wind turbine coupled with a second side of the generator, wherein the first side is opposite the second side

3. The system for generating electricity from wind of claim 1, wherein the vertical mounting pole is coupled with a surface at a bottom portion of the mounting pole, and the frame being rotatably coupled with the vertical mounting pole comprises the vertical mounting pole being coupled with the generator at a top portion of the vertical mounting pole.

4. The system for generating electricity from wind of claim 1, wherein the vertical mounting pole is coupled with a support member at a top portion of the mounting pole, and the frame being rotatably coupled with the vertical mounting pole comprises the vertical mounting pole being coupled with the generator at a bottom portion of the vertical mounting pole.

5. The system for generating electricity from wind of claim 4, wherein the support member is movably coupled with a vertical support element such that the support member moves along a length of the vertical support element.

6. The system for generating electricity from wind of claim 5, wherein the system further comprises a plurality of photovoltaic modules coupled with the support member such that the photovoltaic modules surround a horizontal cross-section of the vertical support element when the support member moves along the length of the vertical support element.

7. The system for generating electricity from wind of claim 6, wherein the support member being movably coupled with the vertical support element comprises the support member being rotatable around the substantially vertical axis.

8. The system for generating electricity from wind of claim 1, wherein the frame being rotatably coupled with the vertical mounting pole comprises the frame coupled with a bearing, and the bearing coupled with the vertical mounting pole.

9. The system for generating electricity from wind of claim 8, wherein:
the frame coupled with the bearing comprises the frame coupled with a first chassis, and the first chassis coupled with the bearing;
the bearing coupled with the vertical mounting pole comprises the bearing coupled with a second chassis, and the second chassis coupled with the vertical mounting pole.

10. The system for generating electricity from wind of claim 9, wherein the system further comprises a slip ring at an interface of the first chassis and the second chassis, wherein the slip ring is configured to transmit electricity between the generator as it rotates and a conductor in the vertical mounting pole, wherein the conductor in the vertical mounting pole is stationary.

11. The system for generating electricity from wind of claim 1, wherein a ratio of a total height of the first vertical axis wind turbine to a total height of the second vertical axis wind turbine is substantially 4:3.

12. The system for generating electricity from wind of claim 1, wherein a ratio of a total diameter of the first vertical axis wind turbine to a total height of the first vertical axis wind turbine is substantially 7:8.

13. The system for generating electricity from wind of claim 1, wherein a ratio of a total diameter of the second vertical axis wind turbine to a total height of the first vertical axis wind turbine is substantially 7:6.

14. A system for generating electricity from fluid flow, wherein the system comprises:
a first means for generating electricity from an input of a first rotational motion, wherein the first means is rotated by a second rotational motion;
a second means for converting at least a portion of energy from a fluid flow into a first rotational motion having a first rotational direction;
a third means for converting at least a portion of energy from the fluid flow into a second rotational motion having a second rotational direction opposite the first rotational direction;
a fourth means for transmitting the first rotational motion to the first means; and
a fifth means for transmitting the second rotational motion to the first means.

15. The system for generating electricity from fluid flow of claim 14, wherein the first means comprises a generator.

16. The system for generating electricity from fluid flow of claim 14, wherein:
the second means comprises a vertical axis wind turbine having vanes in a first direction; and
the third means comprises a vertical axis wind turbine having vanes in a second direction opposite the first direction.

17. The system for generating electricity from fluid flow of claim 14, wherein:
the fourth means comprises a mechanical transmission system; and
the fifth means comprises a mechanical transmission system.

18. The system for generating electricity from fluid flow of claim 14, further comprising a sixth means for rotatably coupling the first means with a surface.

19. The system for generating electricity from fluid flow of claim 18, wherein the sixth means comprise a vertical mounting pole.

20. A method for generating electricity from fluid flow, wherein the method comprises:
receiving a fluid flow with a first vertical axis wind turbine and a second vertical axis wind turbine;
converting energy from the fluid flow into a first rotational motion with the first vertical axis wind turbine;
converting energy from the fluid flow into a second rotational motion with the second vertical axis wind turbine, wherein the second rotational motion is in an opposite direction of the first rotational motion; and
receiving, with a generator, the first rotational motion from a first side of the generator, and the second rotational motion from a second side of the generator, the first side opposite the second side.
